(19) United States
(12) Patent Application Publication
(10) Pub. No.: US 2026/0222408 A1
(43) Pub. Date: Jul. 30, 2026

(54) SECURE STORAGE ACCESS EXCEPTION HANDLING USING A GUEST PROGRAM INTERRUPTION

(71) Applicant: International Business Machines Corporation, Armonk, NY (US)

(72) Inventors: Omkar Ulhas JAVERI, Poughkeepsie, NY (US); Fadi Y. BUSABA, Poughkeepsie, NY (US); Janosch Andreas FRANK, Stuttgart (DE); Lisa Cranton HELLER, Rhinebeck, NY (US); Jonathan D. BRADBURY, Poughkeepsie, NY (US)

(21) Appl. No.: 19/037,205

(22) Filed: Jan. 26, 2025

(51) Int. Cl. H04L 9/40; G06F 9/455

(52) U.S. Cl. CPC H04L 63/10; G06F 9/45558; G06F 2009/45583

(57) ABSTRACT

In some embodiments, a computer system includes a processor set, one or more computer-readable storage media, and program instructions stored on the one or more computer-readable storage media to cause the processor set to perform operations. The operations include determining that a control bit is set to indicate enablement of a secure storage access exception interpretation (SSAEI) state, detecting an attempted access by a second level guest virtual machine of a secure storage associated with a virtual guest virtual machine dispatched by the second level guest virtual machine, instantiated by a first level guest virtual machine as an additional second level guest virtual machine, and presenting, based on enablement of the SSAEI state, a secure storage access exception to the second level guest virtual machine, the secure storage access exception preventing the second level guest virtual machine from accessing the secure storage.

### BACKGROUND

The present invention relates to computer systems, and for example, relates to secure storage access exception handling.

### SUMMARY

In one embodiment, a computer system is provided. In this embodiment, the computer system includes a processor set, one or more computer-readable storage media, and program instructions stored on the one or more computer-readable storage media to cause the processor set to perform operations. The operations include determining that a control bit is set to indicate enablement of a secure storage access exception interpretation (SSAEI) state, detecting an attempted access by a second level guest virtual machine of a secure storage associated with a virtual guest virtual machine dispatched by the second level guest virtual machine, wherein the virtual third level guest virtual machine is instantiated by a first level guest virtual machine as an additional second level guest virtual machine, and presenting, based on enablement of the SSAEI state, a secure storage access exception to the second level guest virtual machine, the secure storage access exception preventing the second level guest virtual machine from accessing the secure storage.

In another embodiment, a computer-implemented method is provided. In this embodiment, the method includes determining whether a control bit is set to indicate enablement of an SSAEI state, detecting an attempted access by a second level guest virtual machine of a secure storage associated with a virtual guest virtual machine dispatched by the second level guest virtual machine, wherein the virtual guest virtual machine is instantiated by a first level guest virtual machine as an additional second level guest virtual machine, and performing an action based on the determining whether the control bit is set to indicate the SSAEI state.

In yet another embodiment, a computer program product is provided. In this embodiment, the computer program product includes one or more computer-readable storage media and program instructions stored on the one or more computer-readable storage media to perform operations. The operations include determining whether a control bit is set to indicate enablement of an SSAEI state, detecting an attempted access by a second level guest virtual machine of a secure storage associated with a virtual guest virtual machine dispatched by the second level guest virtual machine, wherein the virtual guest virtual machine is instantiated by a first level guest virtual machine as an additional second level guest virtual machine, and performing an action based on the determining whether the control bit is set to indicate the SSAEI state.

### BRIEF DESCRIPTION OF THE DRAWINGS

FIGS. 1A and 1B are diagrams of an example system described herein.

FIG. 2 is a diagram showing example implementations of secure storage access exception handling described herein.

FIG. 3 is a diagram of an example computing environment in which systems and/or methods described herein may be implemented.

FIG. 4 is a diagram of example components of one or more devices of FIGS. 1A and 1B.

FIG. 5 is a flowchart of an example process associated with secure storage access exception handling using a guest program interruption.

FIG. 6 is a flowchart of another example process associated with secure storage access exception handling using a guest program interruption.

### DETAILED DESCRIPTION

The following detailed description of example implementations refers to the accompanying drawings. The same reference numbers in different drawings may identify the same or similar elements.

Cloud computing and cloud storage provides users with capabilities to store and process their data in third-party data centers. Cloud computing facilitates the ability to provision a virtual machine (VM) for a customer quickly and easily, without requiring the customer to purchase hardware or to provide floor space for a physical server. The customer may easily expand or contract the VM according to changing preferences or requirements of the customer. Typically, a cloud computing provider provisions the VM, which is physically resident on a server at the provider's data center.

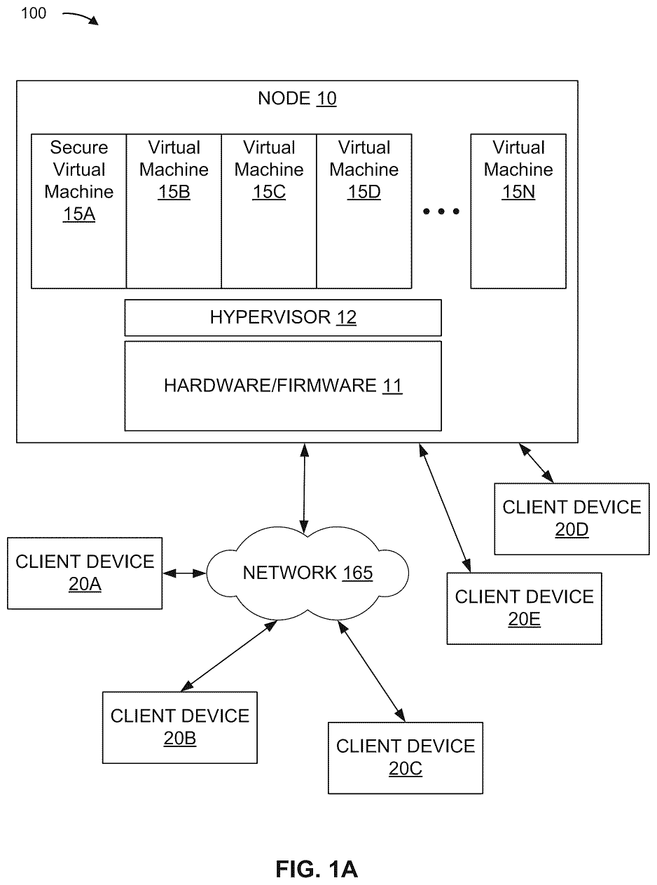

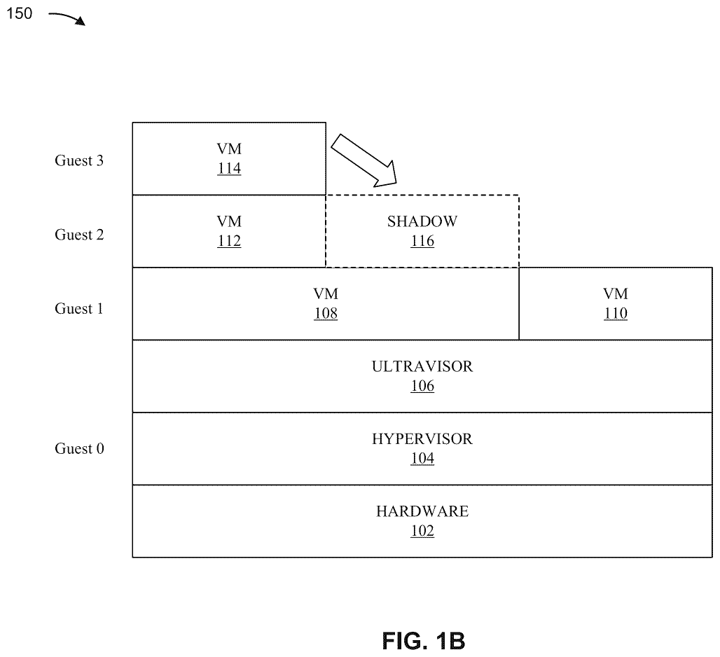

FIG. 1A depicts a system 100 for implementing VMs in accordance with one or more implementations of the present disclosure. The term “virtual machine” or “VM” as used herein refers to a logical representation of a physical machine (computing device, processor, etc.) and its processing environment (operating system (OS), software resources, etc.). The VM is maintained as software that executes on an underlying host machine (physical processor or set of processors). From the perspective of a user or software resource, the VM appears to be its own independent physical machine.

The system 100 includes an example node 10 (e.g., a hosting node) that is in direct or indirect communication with one or more client devices 20A-20E, such as via a network 165. The node 10 can be a datacenter or host server, of a cloud-computing provider. The node 10 may be configured to deploy one or more VMs 15 (15A-15N). Any one or more of the client devices 20A-20E may include a communication apparatus such as a computer, a smartphone, a

tablet computer, a desktop computer, a laptop computer, a server computer, or any other communication apparatus. A client device of the client devices 20A-20E may communicate, via the network 165, with the node 10 to request deployment of a VM (e.g., one or more of the VMs 15A-15N). In this way, one or more of the client devices 20A-20E may facilitate deployment of a VM of the VMs 15A-15N. For example, the VM 15A may be deployed in association with the client device 20A, the VM 15B may be deployed in association with the client device 20B, and the VM 15C may be deployed in association with the client device 20C.

The node 10 executes a hypervisor 12 (which may be referred to as a “VM monitor” (VMM)), which facilitates deploying the one or more VMs 15 (15A-15N). The terms “hypervisor” and “VM monitor (VMM)” as used herein refer to a processing environment or platform service that manages and permits multiple VM's to execute using multiple (and sometimes different) operating systems (OSs) on a same host machine. In some implementations, for example, the hypervisor 12 may be software, firmware, or hardware that creates and runs VMs. The hypervisor 12 facilitates a VM to use the hardware components of the node 10 to execute programs and/or store data. It should be appreciated that deploying a VM includes an installation process of the VM and an activation (or starting) process of the VM. In another example, deploying a VM includes an activation (or starting) process of the VM (e.g., in case the VM is previously installed or already exists). The hypervisor 12 may be a native hypervisor executing on the node 10 directly, or a hosted hypervisor executing on another hypervisor.

A VM, running as a guest under the control of a host hypervisor (e.g., an untrusted entity), relies on that hypervisor to transparently provide virtualization services for that guest. These services can apply to any interface between a secure entity and another untrusted entity that traditionally allows access to the secure resources by this other entity. These services can include, but are not limited to memory management, instruction emulation, and interruption processing. For example, for interrupt and exception injection, the hypervisor typically reads and/or writes into a prefix area (low core) of the guest.

In the case of memory management, for example, a VM can move (page-in) its data from a disk to be resident in memory and the VM can also move its data back out (page-out) to the disk. While the page is resident in memory, the VM (guest) uses a hardware facility called dynamic address translation (DAT) to map the pages in memory from a guest virtual address to a guest absolute address. A virtual address refers to a range of addresses that can appear to be much larger than the physical size of main storage. Virtual addressing may be implemented through DAT and its associated region, segment, and page tables. Region tables point to segment tables, each of which optionally points to a number of page tables (e.g., 2,048-page tables). If present, each page table points to a number of pages (e.g., 256 pages). A page is a block of sequential virtual addresses that spans a predefined amount of memory (e.g., 4 KB).

In addition, the host hypervisor has its own DAT mapping (from host virtual address to host absolute address) for the guest pages in memory and it can, independently and transparently to the guest, page the guest pages in and out of memory. It is through the host DAT tables that the hypervisor provides memory isolation or sharing of guest memory between two separate guest VMs. The host is also able to access the guest memory to simulate guest operations, when necessary, on behalf of the guest.

The node 10 further includes a hardware/firmware layer 11 that provides direct support for functions required by the VMs 15A-N and hypervisor 12 as well as facilitates the hypervisor 12 in providing one or more services to the VMs 15. In some implementations, communication is provided between the hardware/firmware layer 11 and the hypervisor 12, between the hardware/firmware layer 11 and the VMs 15, between the hypervisor 12 and the VMs 15, and between the hypervisor 12 and the VMs 15 via the hardware/firmware layer 11. A secure interface control may be provided in the hardware/firmware layer 11.

Customers are often concerned about the security of data in the VM, particularly since computing providers often store more than one customer's data on the same server. Customers may desire security between their own code/data and the cloud computing provider's code/data, as well as between their own code/data and that of other VMs running at the provider's site. In addition, the customer may desire security from the provider's administrators as well as against potential security breaches from other code running on the machine.

To handle such sensitive situations, cloud service providers may implement security controls to ensure proper data isolation and logical storage segregation. The extensive use of virtualization in implementing cloud infrastructure results in unique security concerns for customers of cloud services as virtualization alters the relationship between an OS and the underlying hardware, be it computing, storage, or even networking hardware. This introduces virtualization as an additional layer that itself must be properly configured, managed and secured.

In some implementations, a logical partition (LPAR) may be used as a virtualization technique to divide a computer's processors, memory, and storage into multiple sets of resources so that each set of resources can be operated independently with its own operating system instance and applications. LPARs may provide a level of abstraction between the physical hardware and the operating systems, similar to virtual machines. However, LPARs may offer more direct access to hardware resources and may be more tightly coupled to the underlying physical system compared to traditional VMs. In the context of secure storage access and exception handling, LPARs may provide an additional layer of isolation and security between different workloads or tenants sharing the same physical hardware. LPARs may work in conjunction with hypervisors to manage resource allocation and security boundaries, potentially influencing how secure storage access exceptions are handled and interpreted across different partitions or virtualized environments.

In addition to LPARs, another important virtualization technology used in mainframe systems is the Processor Resource/Systems Manager (PR/SM). PR/SM may be implemented as a hardware facility that enables the creation and management of LPARs on IBM mainframe systems. PR/SM may allow a single physical machine to be partitioned into multiple logical partitions, each capable of running its own operating system and applications. PR/SM may work at a lower level than traditional hypervisors, providing hardware-assisted virtualization capabilities. It may manage the allocation of physical resources such as processors, memory, and I/O devices to different LPARs. This resource allocation may be dynamic, allowing for efficient utilization of system resources based on workload demands.

In the context of secure storage access and exception handling, PR/SM may facilitate maintaining isolation between different LPARs. It may enforce memory boundaries and access controls at the hardware level, which may complement the security measures implemented by higher-level virtualization technologies and operating systems. PR/SM may work in conjunction with other security features to provide a robust and secure environment for running multiple workloads on a single physical machine. The relationship between PR/SM, LPARs, and higher-level virtualization technologies like hypervisors may form a layered approach to virtualization and security in mainframe environments. This layered architecture may provide multiple levels of isolation and control, potentially enhancing the overall security posture of the system and influencing how secure storage access exceptions are managed across different levels of the virtualization stack.

Secure execution provides a hardware mechanism to facilitate isolation between secure storage and non-secure storage as well as between secure storage belonging to different secure users. For secure guests, additional security is provided between the “untrusted” non-secure hypervisor and the secure guests. In order to do this, many of the functions that the hypervisor typically does on behalf of the guests may be incorporated into the machine. A secure interface control, also referred to herein as an ultravisor (UV), may provide a secure interface between the hypervisor and the secure guests. The terms secure interface control and ultravisor may be used interchangeably herein. The secure interface control works in collaboration with the hardware to provide this additional security.

The secure interface control may be implemented in internal, secure, and trusted hardware and/or firmware. For a secure guest or entity, the secure interface control provides the initialization and maintenance of the secure environment as well as the coordination of the dispatch of these secure entities on the hardware. While the secure guest is actively using data and it is resident in host storage, it is kept “in the clear” in secure storage. Secure guest storage can be accessed by that single secure guest—this being strictly enforced by the hardware. That is, the hardware prevents any non-secure entity (including the hypervisor or other non-secure guests) or different secure guest from accessing that data. In this example, the secure interface control runs as a trusted part of the lowest levels of firmware. The lowest level, or millicode, is really an extension of the hardware and is used to implement the complex instructions and functions defined for example in z/Architecture® from IBM. Millicode has access to all parts of storage, which in the context of secure execution, includes its own secure UV storage, non-secure hypervisor storage, secure guest storage, and shared storage. This allows it to provide any function needed by the secure guest or by the hypervisor in support of that guest. The secure interface control also has direct access to the hardware which allows the hardware to efficiently provide security checks under the control of conditions established by the secure interface control.

Nested virtualization may allow for the creation of VMs within other VMs, effectively establishing a hierarchical structure of virtualization layers. This approach extends the capabilities of traditional virtualization by enabling a hypervisor to run within another hypervisor, creating multiple levels of abstraction between the physical hardware and the uppermost virtual environments. In nested virtualization, each layer of virtualization may have its own guest operating system, resource allocation, and security boundaries, providing enhanced flexibility and isolation for complex computing scenarios.

FIG. 1B illustrates a block diagram of a virtualization system 150 that implements nested virtualization. The system 150 includes multiple layers, starting with a hardware 102 at the bottom. The hardware 102 may include physical computing resources such as processors, memory, storage devices, and network interfaces. These physical resources provide the foundation upon which the virtualization infrastructure is built.

A Level 0 (L0) hypervisor 104 (sometimes referred to interchangeably as “Guest 0 ” or “G0”), also known as the host hypervisor, runs directly on the physical hardware. The Level 0 hypervisor 104 may be partitioned into a number of LPARs. In the context of secure computing environments, nested virtualization may facilitate implementing isolation and compartmentalization strategies. For instance, a secure virtual machine (SVM) may be instantiated within a nested virtualization structure to provide an additional layer of security for sensitive operations or data. A secure interface control, or ultravisor 106, may work in conjunction with the nested virtualization architecture to enforce security policies and manage access to secure resources across different levels of the virtualization hierarchy. The ultravisor 106 is a secure interface control that provides additional security between the hypervisor 104 and secure guests. The ultravisor 106 may be implemented in internal, secure, and trusted hardware and/or firmware. The ultravisor 106 works in collaboration with the hardware to provide enhanced security features, such as isolation between secure storage and non-secure storage, as well as between secure storage belonging to different secure users.

Above the Level 0 hypervisor 104, one or more Level 1 (L1) VMs 108 and 110, or guest hypervisors (sometimes referred to herein interchangeably as “Guest 1”), operate as a VM created by the L0 hypervisor 104. As used herein, the term “first level guest” may refer to a virtual machine or environment that is directly managed by the primary hypervisor (L0) in a nested virtualization setup. First level guests may have the capability to run their own guest operating systems.

The L1 hypervisors (VMs 108 and 110) can then create their own VMs, referred to as Level 2 (L2) VMs (e.g., sometimes referred to herein as “Guest 2” VMs). For example, as shown, the L1 VM 108 may deploy an L2 VM 112. The term “second level guest” may describe a virtual machine or environment that is created and managed by a first level guest acting as a hypervisor. Second level guests operate at a higher level of abstraction from the physical hardware and may be subject to additional layers of resource translation and management.

A “virtual third level guest” may refer to a VM or environment that is created and managed by a second level guest acting as a hypervisor. This represents a further level of nesting in the virtualization hierarchy, potentially introducing additional complexity in resource management and performance considerations. In many implementations, central processing unit (CPU) architectures allow for only one or two levels of hardware-assisted virtualization. For example, the z/Architecture® provided by IBM supports two levels of virtualization natively. This means that the system can provide hardware support for the host (or “primary”) hypervisor (Level 0 or L0) running directly on the physical hardware, a first level guest (“secondary” hypervisor) (Level 1 or L1), and a second level guest (another “secondary” or “nested”) (Level 2 or L2) hypervisor. However, the concept of nested virtualization may extend beyond these two levels (L1 and L2) of virtualization. When a third level of virtualization (Level 3 or L3) is desired, it may be implemented as a virtual hypervisor. For example, as shown, the L2 guest VM 112 may dispatch a virtual L3 guest VM 114. Similarly, any number of additional levels of nesting may be employed, resulting in virtual fourth level guests, virtual fifth level guests, and the like.

To facilitate nested virtualization, a start interpretive execution (SIE) instruction may be used. As an example, the L0 hypervisor 104 may dispatch a guest CPU using an SIE instruction. The operand of the SIE instruction defines the state of the guest CPU and is referred to as a “state description.” In this case, control is given to firmware and hardware and an L1 guest (e.g., the VM 108) may be dispatched (e.g., started or created). If an L1 hypervisor such as the VM 108 executes a SIE instruction, an L2 guest (e.g., the VM 112) may be dispatched. However, if the L2 guest VM 112 tries to execute a SIE instruction, control will not be given to firmware, because there is no hardware support for an L3 guest, so control will be given to the L1 guest VM 108. The L1 guest VM 108 may start an L3 guest VM 114, running as an L2 guest (e.g., based on the CPU state description). This way, the new guest will have some hardware support. On IBM's z/Architecture, this type of nesting is referred to as Virtual SIE (VSIE). When the L2 guest dispatches (e.g., starts) a guest, the L1 guest will look at the data structure and copy specific values from that data structure into its own copy, referred to as a “shadow” copy, because it shadows the L3 guest data structure. Thus, the L2 guest VM 112 includes the original data structure used to start the L3 guest VM 114, and the L1 guest includes a shadow data structure to run the L3 guest VM 114 as a shadow 116, which is an L2 guest. In this way, any number of levels of VMs may be dispatched. For example, the system 150 may include L4 guests, L5 guests, . . . , LN guests, and L(N+1) guests, where N may be any positive integer.

In the context of secure computing environments, a secure-storage-access exception is recognized when the CPU attempts to reference a main-storage location that is a secure location when operating in the non-secure mode. One such exception may include a Program Interruption Code (PIC), which may be a value that identifies the specific cause of a program interruption in certain computer architectures, such as IBM's z/Architecture®, a program interruption code (PIC) 0x3D, which corresponds to a decimal value of 61, may be associated with secure storage access exceptions in some implementations. Examples of situations that may trigger a PIC 0x3D (secure storage access exception) include a non-secure VM attempting to access memory pages allocated to a secure VM, and a hypervisor attempting to directly access the secure storage of a guest VM without proper authorization. In some implementations, for example, the secure storage access exception may include an attempted access by an (N)th level non-secure VM to a secure storage of an (N+1)th level VM.

A secure storage access exception interpretation (SSAEI) state may influence how these exceptions are managed across different virtualization levels. When the SSAEI state is enabled, it may allow for more granular control over exception handling, potentially enabling direct interpretation of secure storage access exceptions by second level guest hypervisors, reducing the need to exit to the host program. This may allow for custom exception handling routines tailored to specific security requirements of nested VMs, enhanced isolation between secure and non-secure storage areas across multiple virtualization layers, improved performance by reducing the number of transitions between different virtualization levels when handling secure storage access exceptions, and more efficient emulation of secure storage access behaviors for virtual third level guests.

Some challenges stem from the current approach where guest and host secure-storage-access exceptions result in mandatory host program interruption. Typically, if a level 2 guest is running and a secure storage access exception occurs, the exception is presented to the host hypervisor (e.g., the level 1 hypervisor). In some cases, the level 2 guest may touch a page (e.g., via a writing operation or a reading operation) that is secure. In some cases, for example, a level 3 guest (running as a level 2 guest) may have a secure page that would be in the level 2 guest's memory (since the level 2 guest dispatched the level 3 guest). If the level 2 guest tries to access the secure page, it may receive the secure storage access exception. However, in some cases, the level two guest will exit out to the level one guest.

In some cases, this process can introduce a round-trip issue. When a Guest 2 encounters a secure storage access exception as a result of attempting to access a secure page belonging to a Guest 3, the system has to exit to Guest 1, which then needs to forward the exception back to Guest 2, as the Guest 2 is acting as the host for the Guest 3. However, the Guest 1 lacks information about the Guest 2 virtual address space, making it challenging to inject the exception correctly back to Guest 2. This round trip (G2->SIE exit->G1->SIE entry->G2) is not only inefficient but also introduces significant performance overhead.

The current architecture lacks a mechanism for Guest 2 to directly interpret and handle secure storage access exceptions without involving Guest 1. This limitation forces the system to always exit to the higher-level hypervisor, even in cases where Guest 2 may be capable of handling the exception more efficiently. The absence of fine-grained control over exception handling at the Guest 2 level results in unnecessary context switches, increased latency, and potential security vulnerabilities as sensitive information may need to be passed between different virtualization layers. To facilitate secure guests at level 3, however, the Guest 2 would need to have the same exception support that the Guest 1 has so that those exceptions can be interpreted at Guest 2.

Implementations of this disclosure address problems such as these by enabling secure storage access exception handling using guest program interruption in nested virtualization environments. A computer system determines that a control bit is set to indicate enablement of an SSAEI state. As used herein, the term “control bit” refers to a specific bit in a state description that controls how secure storage access exceptions are handled. The system detects an attempted access by a second level guest VM of a secure storage associated with a virtual guest VM dispatched by the second level guest VM. The virtual guest VM may be, for example, a virtual third level guest. In other examples, the attempted access may be an attempted access of a secure storage of an (N+1)th level guest VM by an Nth level guest VM.

Based on the enablement of the SSAEI state, the system presents a secure storage access exception to the second level guest VM (or the Nth level guest VM), preventing it from accessing the secure storage. This approach allows for more efficient handling of secure storage access exceptions by enabling direct interpretation at the second level guest, reducing the need for exits to higher-level hypervisors. The control bit may be included in a state description associated with the second level guest VM, and the second level guest VM may be a hypervisor for the virtual guest VM (e.g., the (N+1)th level guest VM). In some implementations, the control bit and/or the state description may be included in an SIE instruction. Further, although the examples described herein are limited to scenarios involving an attempted access to a secure storage of a third level guest VM (the “virtual guest VM”) by a second level guest VM, the techniques described herein may apply similarly to an attempted access to a secure storage of an (N+1)th level guest VM (a “virtual guest VM”) by an Nth level guest VM.

Furthermore, the system may determine that an interception control bit is set to a first value of a pair of available values (e.g., a first value and a second value), where presenting the secure storage access exception to the second level guest VM may be based on determining that the interception control bit is set to the first value. For example, the first value may be “0” or “1.” In this way, some implementations provide additional granularity in controlling exception handling behavior. The secure storage access exception may be interpreted based on a second level guest VM virtual address. By handling the secure storage access exception as a guest program interruption without causing a program interruption interception associated with the first level guest VM, the system reduces context switches and improves overall performance in nested virtualization scenarios. This approach enables more efficient and secure operation of complex virtualized environments, particularly those involving multiple levels of nested virtual machines and secure execution requirements.

In some implementations, the system enables SSAEI for second level guest VMs. Accordingly, an advantage of the SSAEI enablement is that it allows for more efficient handling of secure storage access exceptions by enabling direct interpretation at the second level guest, reducing the need for exits to higher-level hypervisors. Additionally, an advantage of the SSAEI enablement is that it improves overall system performance by reducing context switches and minimizing the overhead associated with exception handling in nested virtualization environments.

In some implementations, the system provides a second level guest VM virtual address to facilitate accurate exception handling. Accordingly, an advantage of providing this virtual address is that it enables more precise and targeted exception handling, allowing the second level guest VM to accurately identify and manage secure storage access violations. Additionally, an advantage of providing this virtual address is that it enhances the security posture of the system by ensuring that exceptions are handled at the appropriate virtualization level, maintaining proper isolation between different levels of nested virtual machines.

In some implementations, the system handles secure storage access exceptions as guest program interruptions without causing program interruption interceptions associated with the first level guest VM. Accordingly, an advantage of this approach is that it significantly reduces the number of transitions between different virtualization levels, leading to improved system efficiency and reduced latency in exception handling. Additionally, an advantage of this approach is that it enhances the scalability of nested virtualization environments by allowing for more efficient management of secure storage access exceptions across multiple levels of virtual machines, potentially enabling support for deeper levels of nesting without compromising performance or security.

As indicated above, FIGS. 1A and 1B are provided as examples. Other examples may differ from what is described with regard to FIGS. 1A and 1B. The number and arrangement of devices shown in FIGS. 1A and 1B are provided as an example. There may be additional devices (e.g., a large number of devices), fewer devices, different devices, or differently arranged devices than those shown in FIGS. 1A and 1B. Furthermore, two or more devices shown in FIGS. 1A and 1B may be implemented within a single device, or a single device shown in FIGS. 1A and 1B may be implemented as multiple, distributed devices. Additionally, or alternatively, a set of devices (e.g., one or more devices) shown in FIGS. 1A and 1B may perform one or more functions described as being performed by another set of devices shown in FIGS. 1A and 1B.

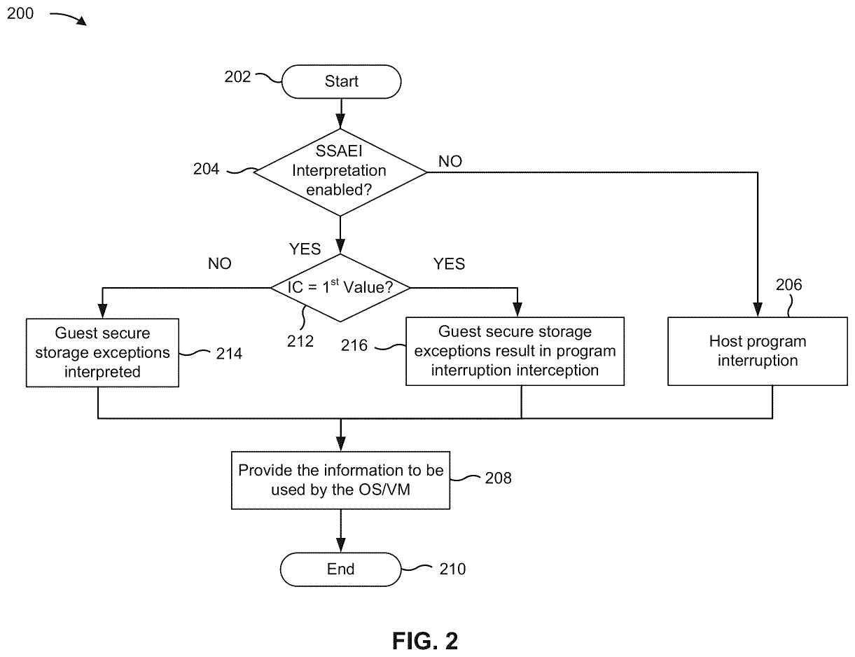

FIG. 2 illustrates aspects of a process 200 associated with secure storage access exception handling in a nested virtualization environment. The process 200 may be performed, for example, by the hardware 102 acting on behalf of the hypervisor 104, the VM 108 and/or the VM112 shown in FIG. 1B, and/or the hardware/firmware 11 shown in FIG. 1A.

The process 200 begins at step 202, which represents the start of the secure storage access exception handling procedure. This initial step may involve system initialization or the occurrence of a secure storage access event that triggers the exception handling process.

At step 204, the system determines whether SSAEI is enabled. The system may check whether a control bit is set to indicate enablement of the SSAEI state. In some implementations, this control bit may be a bit in the execution controls of a state description. The state description may be part of an SIE instruction obtained from the first level guest hypervisor. The system may examine the control bit within the state description to determine if it is set to a value indicating SSAEI enablement. This determination may involve reading a specific bit or flag within the execution controls of the state description.

In some cases, the determination may also involve checking additional control bits or flags. For example, the system may determine if an interception control (IC) bit is set to a first value of a first value and a second value. The combination of the SSAEI enablement bit and other control bits may provide more granular control over how secure storage access exceptions are handled. If the control bit is set to indicate enablement of the SSAEI state, the second level guest VM may be authorized to intercept and handle secure storage access exceptions without exiting to the first level guest hypervisor. This may allow for more efficient exception handling by reducing the need for context switches between different virtualization levels.

If SSAEI is not enabled (NO branch from step 204), the process moves to step 206, which involves a host program interruption. For example, if the secure storage access exception is a guest 2 (G2) secure storage access exception, step 206 involves a mandatory host (G1 hypervisor) program interruption. If the secure storage access exception is a host (G1) secure storage access exception, step 206 involves a host (G1) program interruption. This interpretation may involve traditional exception handling methods that require exiting to higher-level hypervisors, potentially introducing performance overhead due to multiple context switches.

If SSAEI is enabled (YES branch from step 204), the process proceeds to step 212, where it checks if the IC bit is set to a first value of a first value and a second value. The IC bit may serve as an additional control mechanism for fine-tuning the exception handling behavior. This multi-bit control scheme may allow for more granular management of secure storage access exceptions across different virtualization levels.

If the IC is not set to the first value (NO branch from step 212) (e.g., if the IC bit is set to the second value), the process moves to step 214, where guest secure storage access exceptions result in a program interruption. In this case, the second level guest VM may interpret the secure storage access exception, at the second level guest VM, based on the enablement of the SSAEI state. In this way, the second level guest VM may then perform the secure storage access exception interpretation without exiting to a first level guest hypervisor.

In some implementations, intercepting the secure storage access exception may involve capturing and analyzing the exception details within the context of the second level guest VM. This may include examining memory access patterns, security flags, and other relevant data to determine the nature and severity of the exception.

The secure storage access exception interpretation performed by the second level guest VM may involve various actions. For example, the second level guest VM may analyze the exception context, determine the appropriate response, and potentially resolve the exception without involving higher-level hypervisors. This may include updating access permissions, modifying memory mappings, or taking other corrective actions as needed.

If the IC bit is set to the first value (YES branch from step 212), the process proceeds to step 216, which results in a program interruption interception, which results in an SIE exit. This path may be taken in scenarios where higher-level intervention is necessary or desired for handling the secure storage access exception.

After steps 214, 216, or 206, the process moves to step 208, where it provides the information to be used by the operating system or VM. This step may facilitate ensuring that the relevant exception information is communicated to the appropriate software layer for further processing or logging. In some implementations, this may involve providing a second level guest VM virtual address to facilitate accurate exception handling.

The process 200 concludes at step 210, representing the end of the secure storage access exception handling procedure.

As indicated above, FIG. 2 is provided as an example. Other examples may differ from what is described with regard to FIG. 2.

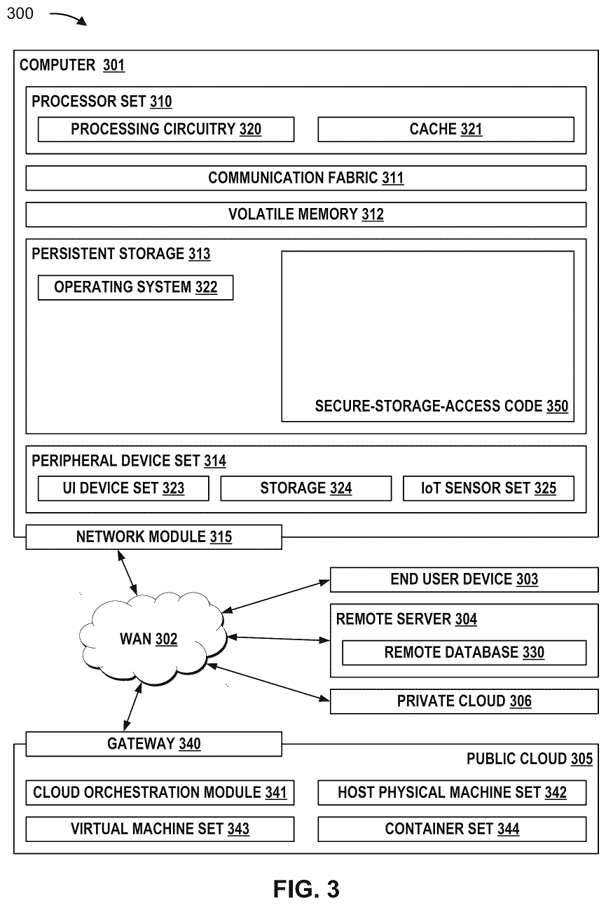

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as secure-storage-access code, included in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

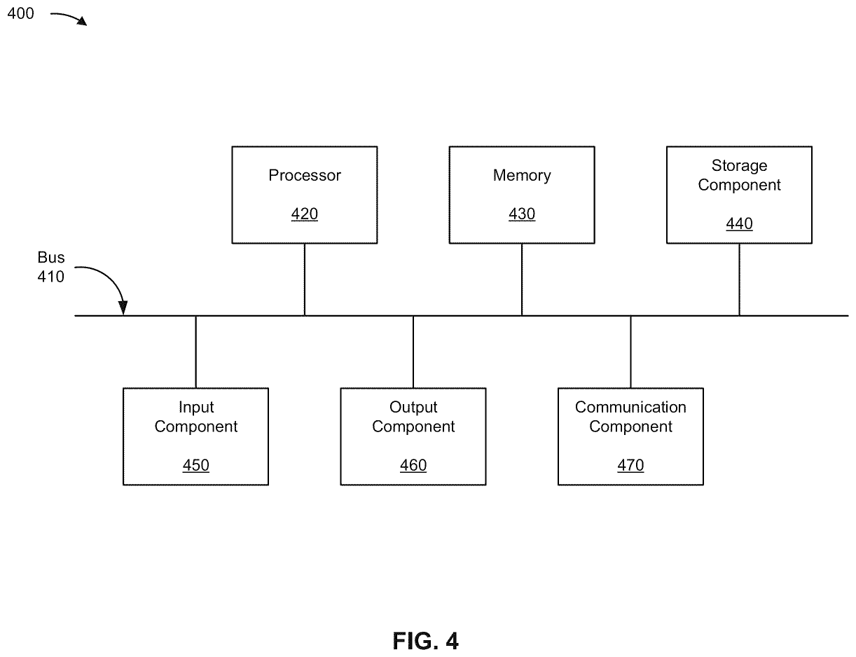

FIG. 4 is a diagram of example components of a device 400, which may correspond to node 10 shown in FIG. 1A. In some implementations, the node 10 may include one or more devices of the computing environment 300 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

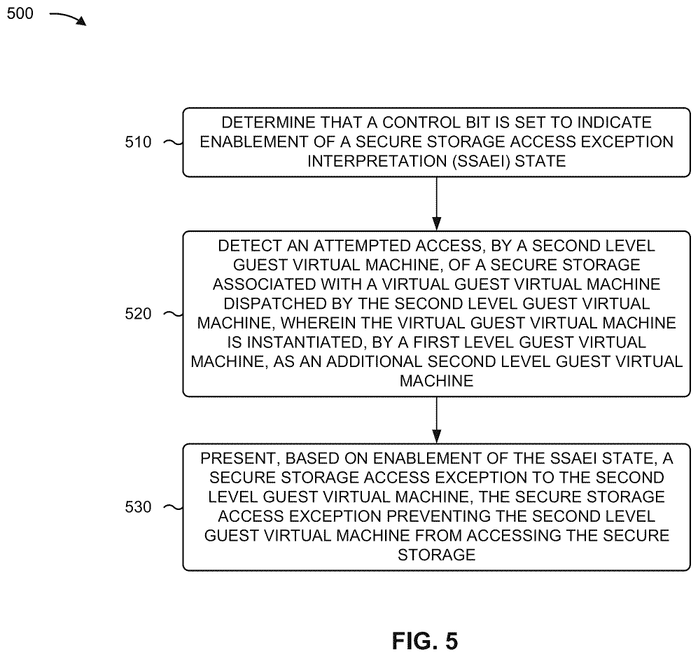

FIG. 5 is a flowchart of an example process 500 associated with secure storage access exception handling using a guest program interruption. In some implementations, one or more process blocks of FIG. 5 may be performed by a “processor set” which may include the hardware 102 acting on behalf of the hypervisor 104, the VM 108 and/or the VM112 shown in FIG. 1B, and/or the hardware/firmware 11 shown in FIG. 1A. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include determining that a control bit is set to indicate enablement of an SSAEI state (block 510). For example, the processor set may determine that a control bit is set to indicate enablement of an SSAEI state, as described above. In some implementations, the control bit is included in a state description associated with the second level guest VM, and the second level guest VM is a hypervisor for the virtual guest VM. In some implementations, the state description is included in an SIE instruction.

As shown in FIG. 5, process 500 may include detecting an attempted access, by a second level guest VM, of a secure storage associated with a virtual guest VM dispatched by the second level guest VM, wherein the virtual guest VM is instantiated, by a first level guest VM, as an additional second level guest VM (block 520). For example, the processor set may detect an attempted access, by a second level guest VM, of a secure storage associated with a virtual guest VM dispatched by the second level guest VM, wherein the virtual guest VM is instantiated, by a first level guest VM, as an additional second level guest VM, as described above.

As shown in FIG. 5, process 500 may include presenting, based on enablement of the SSAEI state, a secure storage access exception to the second level guest VM, the secure storage access exception preventing the second level guest VM from accessing the secure storage (block 530). For example, the processor set may present, based on enablement of the SSAEI state, a secure storage access exception to the second level guest VM, the secure storage access exception preventing the second level guest VM from accessing the secure storage, as described above.

In some implementations, process 500 includes determining that an interception control bit is set to a first value of a first value and a second value, and presenting the secure storage access exception is further based on determining that the interception control bit is set to the first value. In some implementations, presenting the secure storage access exception includes interpreting the secure storage access exception based at least in part on a second level guest VM virtual address. In some implementations, presenting the secure storage access exception includes handling the secure storage access exception as a guest program interruption without causing a program interruption interception associated with the first level guest VM.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

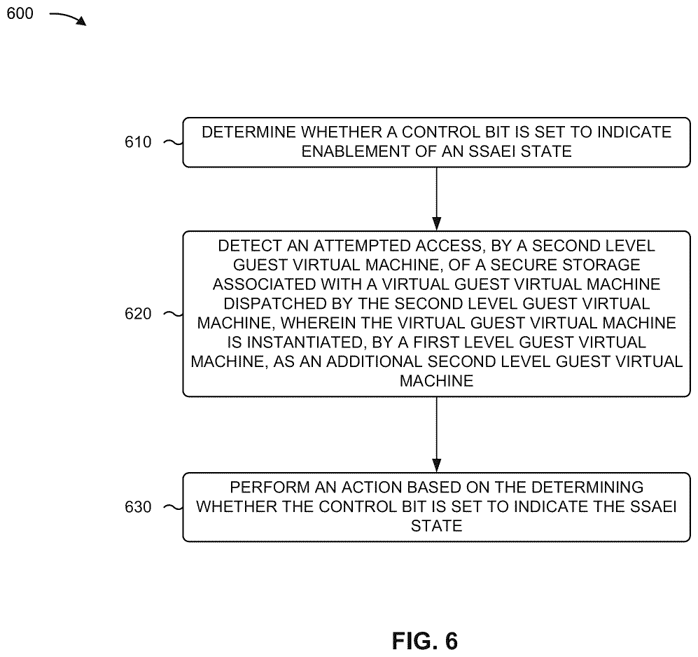

FIG. 6 is a flowchart of an example process 600 associated with secure storage access exception handling using a guest program interruption. In some implementations, one or more process blocks of FIG. 6 may be performed by a “processor set” which may include the hardware 102 acting on behalf of the hypervisor 104, the VM 108 and/or the VM112 shown in FIG. 1B, and/or the hardware/firmware 11 shown in FIG. 1A. Additionally, or alternatively, one or more process blocks of FIG. 6 may be performed by one or more components of device 400, such as processor 420, memory 430, storage component 440, input component 450, output component 460, and/or communication component 470.

As shown in FIG. 6, process 600 may include determining whether a control bit is set to indicate enablement of an SSAEI state (block 610). For example, the processor set may determine whether a control bit is set to indicate enablement of an SSAEI state, as described above.

Process 600 may include detecting an attempted access, by a second level guest VM of a secure storage associated with a virtual guest VM dispatched by the second level guest VM, wherein the virtual guest VM is instantiated, by a first level guest VM, as an additional second level guest VM (block 620). For example, the processor set may detect an attempted access, by a second level guest VM of a secure storage associated with a virtual guest VM dispatched by the second level guest VM, wherein the virtual guest VM is instantiated, by a first level guest VM, as an additional second level guest VM, as described above.

Process 600 may include performing an action based on the determining whether the control bit is set to indicate the SSAEI state (block 630). For example, the processor set may perform an action based on the determining whether the control bit is set to indicate the SSAEI state, as described above.

In some implementations, determining whether the control bit is set to indicate the enablement of the SSAEI state includes determining that the control bit is set to indicate the enablement of the SSAEI state, and performing the action includes presenting, based on the determining that the control bit is set to indicate the enablement of the SSAEI state, a secure storage access exception to the second level guest VM, the secure storage access exception preventing the second level guest VM from accessing the secure storage.

In some implementations, presenting the secure storage access exception includes handling the secure storage access exception as a guest program interruption without causing a program interruption interception associated with the first level guest VM. In some implementations, the control bit is included in a state description associated with the second level guest VM, and the second level guest VM is a hypervisor for the virtual guest VM. In some implementations, the state description is included in an SIE instruction.

In some implementations, determining whether the control bit is set to indicate the enablement of the SSAEI state includes determining that the control bit is set to indicate the enablement of the SSAEI state, and process 600 includes determining that an interception control bit is set to a first value of a first value and a second value, where performing the action includes presenting, based on the determining that the interception control bit is set to the first value, a secure storage access exception to the second level guest VM, the secure storage access exception preventing the second level guest VM from accessing the secure storage.

In some implementations, determining whether the control bit is set to indicate the enablement of the SSAEI state includes determining that the control bit is set to indicate a disablement of the SSAEI state, where performing the action includes exiting, based on the determining that the control bit is set to indicate a disablement of the SSAEI state, to a host program for handling the secure storage access exception.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Embodiments of the invention disclosed herein may include system, method, and/or computer program product (herein a system) that implement secure interface control high-level page management. Note that, for each of explanation, identifiers for elements are reused for other similar elements of different figures.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer system comprising:
a processor set;
one or more computer-readable storage media; and
program instructions stored on the one or more computer-readable storage media to cause the processor set to perform operations comprising:
determining that a control bit is set to indicate enablement of a secure storage access exception interpretation (SSAEI) state;
detecting an attempted access, by a second level guest virtual machine, of a secure storage associated with a virtual guest virtual machine dispatched by the second level guest virtual machine, wherein the virtual guest virtual machine is instantiated, by a first level guest virtual machine, as an additional second level guest virtual machine; and
presenting, based on enablement of the SSAEI state, a secure storage access exception to the second level guest virtual machine, the secure storage access exception preventing the second level guest virtual machine from accessing the secure storage.

2. The computer system of claim 1, wherein the control bit is included in a state description associated with the second level guest virtual machine, wherein the second level guest virtual machine is a hypervisor for the virtual guest virtual machine.

3. The computer system of claim 2, wherein the state description is included in a start interpretive execution (SIE) instruction.

4. The computer system of claim 1, the operations further comprising:
determining that an interception control bit is set to a first value of a first value and a second value, wherein the presenting the secure storage access exception is further based on determining that the interception control bit is set to the first value.

5. The computer system of claim 1, wherein the presenting the secure storage access exception comprises:
interpreting the secure storage access exception based at least in part on a second level guest virtual machine virtual address.

6. The computer system of claim 1, wherein the virtual guest virtual machine comprises a virtual third level guest virtual machine.

7. The computer system of claim 1, wherein the presenting the secure storage access exception comprises:
handling the secure storage access exception as a guest program interruption without causing a program interruption interception associated with the first level guest virtual machine.

8. A computer-implemented method comprising:
determining whether a control bit is set to indicate enablement of a secure storage access exception interpretation (SSAEI) state;
detecting an attempted access, by a second level guest virtual machine, of a secure storage associated with a virtual guest virtual machine dispatched by the second level guest virtual machine, wherein the virtual guest virtual machine is instantiated, by a first level guest virtual machine, as an additional second level guest virtual machine; and
performing an action based on the determining whether the control bit is set to indicate the SSAEI state.

9. The computer-implemented method of claim 8, wherein the determining whether the control bit is set to indicate the enablement of the SSAEI state comprises:
determining that the control bit is set to indicate the enablement of the SSAEI state, and wherein the performing the action comprises:
presenting, based on the determining that the control bit is set to indicate the enablement of the SSAEI state, a secure storage access exception to the second level guest virtual machine, the secure storage access exception preventing the second level guest virtual machine from accessing the secure storage.

10. The computer-implemented method of claim 9, wherein the presenting the secure storage access exception comprises:
handling the secure storage access exception as a guest program interruption without causing a program interruption interception associated with the first level guest virtual machine.

11. The computer-implemented method of claim 8, wherein the control bit is included in a state description associated with the second level guest virtual machine, and wherein the second level guest virtual machine is a hypervisor for the virtual guest virtual machine.

12. The computer-implemented method of claim 11, wherein the state description is included in a start interpretive execution (SIE) instruction.

13. The computer-implemented method of claim 8, wherein the determining whether the control bit is set to indicate the enablement of the SSAEI state comprises:
determining that the control bit is set to indicate the enablement of the SSAEI state, the method further comprising:
determining that an interception control bit is set to a first value of a first value and a second value, wherein the performing the action comprises:
presenting, based on the determining that the interception control bit is set to the first value, a secure storage access exception to the second level guest virtual machine, the secure storage access exception preventing the second level guest virtual machine from accessing the secure storage.

14. The computer-implemented method of claim 8, wherein the determining whether the control bit is set to indicate the enablement of the SSAEI state comprises:
determining that the control bit is set to indicate a disablement of the SSAEI state, wherein the performing the action comprises:
exiting, based on the determining that the control bit is set to indicate a disablement of the SSAEI state, to a host program for handling the secure storage access exception.

15. A computer program product comprising:
one or more computer-readable storage media; and
program instructions stored on the one or more computer-readable storage media to perform operations comprising:
determining whether a control bit is set to indicate enablement of a secure storage access exception interpretation (SSAEI) state;
detecting an attempted access, by a second level guest virtual machine, of a secure storage associated with a virtual guest virtual machine dispatched by the second level guest virtual machine, wherein the virtual guest virtual machine is instantiated, by a first level guest virtual machine, as an additional second level guest virtual machine; and
performing an action based on the determining whether the control bit is set to indicate the SSAEI state.

16. The computer program product of claim 15, wherein the determining whether the control bit is set to indicate the enablement of the SSAEI state comprises:
determining that the control bit is set to indicate the enablement of the SSAEI state, and wherein the performing the action comprises:
presenting, based on the determining that the control bit is set to indicate the enablement of the SSAEI state, a secure storage access exception to the second level guest virtual machine, the secure storage access exception preventing the second level guest virtual machine from accessing the secure storage.

17. The computer program product of claim 16, wherein the presenting the secure storage access exception comprises:
handling the secure storage access exception as a guest program interruption without causing a program interruption interception associated with the first level guest virtual machine.

18. The computer program product of claim 15, wherein the control bit is included in a state description associated with the second level guest virtual machine, and wherein the second level guest virtual machine is a hypervisor for the virtual guest virtual machine.

19. The computer program product of claim 15, wherein the determining whether the control bit is set to indicate the enablement of the SSAEI state comprises:
determining that the control bit is set to indicate the enablement of the SSAEI state, the operations further comprising:
determining that an interception control bit is set to a first value of a first value and a second value, wherein the performing the action comprises:
presenting, based on the determining that the interception control bit is set to the first value, a secure storage access exception to the second level guest virtual machine, the secure storage access exception preventing the second level guest virtual machine from accessing the secure storage.

20. The computer program product of claim 15, wherein the determining whether the control bit is set to indicate the enablement of the SSAEI state comprises:
determining that the control bit is set to indicate a disablement of the SSAEI state, wherein the performing the action comprises:
exiting, based on the determining that the control bit is set to indicate a disablement of the SSAEI state, to a host program for handling the secure storage access exception.
